(19) United States
(12) Patent Application Publication
(10) Pub. No.: US 2017/0057536 A1
(43) Pub. Date: Mar. 2, 2017

(54) ELECTRONIC RELEASE LINKAGE WITH COLLAPSIBLE LINK MEMBER FOR VEHICLE STEERING COLUMN

(71) Applicant: Steering Solutions IP Holding Corporation, Saginaw, MI (US)

(72) Inventors: Michael C. Vermeersch, Essexville, MI (US); Arthur W. Nellett, Davison, MI (US); James E. Rouleau, Burt, MI (US); Shawn A. Haring, Swartz Creek, MI (US)

(21) Appl. No.: 14/880,775

(22) Filed: Oct. 12, 2015

Related U.S. Application Data
(63) Continuation-in-part of application No. 14/839,288, filed on Aug. 28, 2015.

(51) Int. Cl. B62D 1/184

(52) U.S. Cl. CPC B62D 1/184

(57) ABSTRACT

An electronic release linkage assembly for a vehicle steering column includes a stationary portion of a steering column. Also included is a module mounting bracket of an electronic release module, the module mounting bracket coupled to the stationary portion. Further included is a cam bracket assembly operatively coupled to a steering column mounting bracket, the cam bracket assembly configured to selectively apply a clamping force on the steering column upon receipt of input from the electronic release module, the cam bracket assembly comprising a lever arm rotatable about a cam axis. Yet further included is a link member that is collapsible and operatively coupled at a first link member end to the electronic release module and at a second link member end to the lever arm, the collapsible link member configured to collapse in response to a load imparted by the cam bracket assembly in excess of a predetermined load.

### CROSS-REFERENCES TO RELATED APPLICATIONS

This patent application is a continuation-in-part of, and claims priority to, U.S. patent application Ser. No. 14/839,288, filed Aug. 28, 2015, which is incorporated herein by reference in its entirety.

### BACKGROUND OF THE INVENTION

The subject matter disclosed herein relates to vehicle steering columns and, more particularly, to an electronic release module linkage assembly with a collapsible link member for such steering columns.

Some steering columns may be adjustable in a rake direction and a telescope direction. A traditional adjustable steering column includes a jacket clamp positioned about a steering column jacket and configured to apply a clamping force to the steering column jacket to prevent adjustment of the steering column in the telescope direction. In addition, a traditional adjustable steering column may include a rake clamp configured to apply a clamping force to the jacket clamp and/or steering column jacket to prevent adjustment of the steering column in the rake direction. The adjustable steering column is in a locked condition when the telescope clamp and the rake clamp respectively apply clamping forces to prevent adjustment of the adjustable steering column in the rake and telescope directions. The adjustable steering column is in an unlocked condition when respective clamping forces from the telescope clamp and the rake clamp are released so that the steering column may be adjusted.

The clamping force may be released by mechanical components controlled by an electronic release module that is coupled to a cam bracket. Unfortunately, requiring coupling of the electronic release module to the cam bracket limits the mounting location for different steering columns, which may have different dimensions and geometries. Mounting to the cam bracket cantilevers the electronic release module to the steering column. Undesirably, steering column designs that are cantilever in nature generally have low stiffness and poor natural frequency.

### SUMMARY OF THE INVENTION

In accordance with an exemplary embodiment of the invention, an electronic release linkage assembly for a vehicle steering column. The linkage assembly includes a stationary portion of a steering column. Also included is a module mounting bracket of an electronic release module, the module mounting bracket coupled to the stationary portion of the steering column. Further included is a cam bracket assembly operatively coupled to a steering column mounting bracket, the cam bracket assembly configured to selectively apply a clamping force on the steering column upon receipt of input from the electronic release module, the cam bracket assembly comprising a lever arm rotatable about a cam axis. Yet further included is a link member that is collapsible and operatively coupled at a first link member end to the electronic release module with a gear pin extending from the electronic release module, the link member operatively coupled at a second link member end to the lever arm, the link member transferring an input from the electronic release module to drive rotation of the lever arm, the collapsible link member configured to collapse in response to a load imparted by the cam bracket assembly in excess of a predetermined load.

In accordance with another exemplary embodiment of the invention, a steering column assembly includes a stationary portion of a steering column. Also included is a moveable portion of a steering column in telescoping engagement with the stationary portion. Further included is a module mounting bracket directly coupled to the stationary portion of the steering column. Yet further included is an electronic release module operatively coupled to the module mounting bracket. Also included is a steering column mounting bracket operatively coupled to the stationary portion of the steering column. Further included is a lever arm of a cam bracket assembly operatively coupled to the steering column mounting bracket and rotatable about a cam axis. Yet further included is a link member that is collapsible and operatively coupled at a first link member end to the electronic release module and operatively coupled at a second link member end to the lever arm, the collapsible link member configured to collapse in response to a load imparted by the cam bracket assembly in excess of a predetermined load.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a steering column assembly with an electronic release module;

FIG. 2 is a perspective, disassembled view of the steering column assembly;

FIG. 3 is a perspective, disassembled view of a linkage assembly of the electronic release module;

FIG. 4 is a perspective view of a guide member of the linkage assembly;

FIG. 5 is a perspective view of a lever arm of the linkage assembly;

FIG. 6 is a perspective view of a cam of the linkage assembly;

FIG. 7 is a perspective view of the linkage assembly in a pre-assembled condition;

FIG. 8 is a perspective view of the linkage assembly in an assembled condition;

FIG. 9 is a cross-sectional view of an end portion of a link member of the linkage assembly according to another aspect of the disclosure;

FIG. 10 is a perspective view of the linkage assembly according to another aspect of the disclosure in a pre-assembled condition;

FIG. 11 is a perspective view of the linkage assembly of FIG. 10 according to another aspect of the disclosure;

FIG. 12 is a perspective view of the linkage assembly of FIG. 10 according to another aspect of the disclosure.

FIG. 13 is a perspective view of the lever arm and the guide member;

FIG. 14 is a perspective view of a cam ramp of the cam;

FIG. 15 is a perspective view of a wheel engaged with the cam ramp;

FIG. 16 is a perspective view of the link member with a cutout portion to facilitate collapsibility of the link member;

FIG. 17 is a perspective view of the link member of FIG. 16 in a collapsed condition;

FIG. 18 is a view of the steering column assembly with a stationary rake bolt;

FIG. 19 is an enlarged view of the stationary rake bolt;

FIG. 20 is a perspective view of the stationary rake bolt.

### DETAILED DESCRIPTION

Referring now to the Figures, where the invention will be described with reference to specific embodiments, without limiting same,

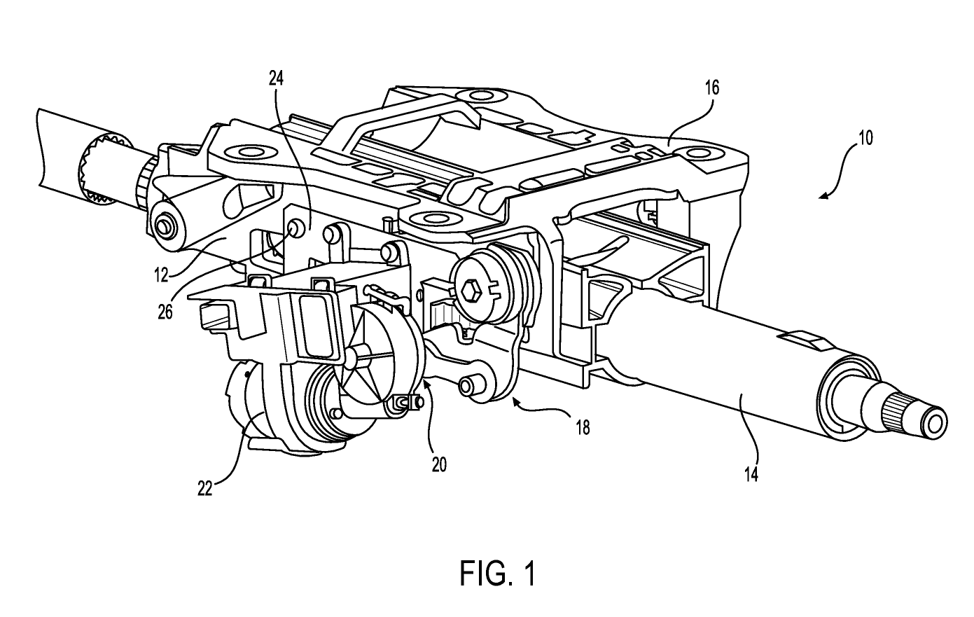

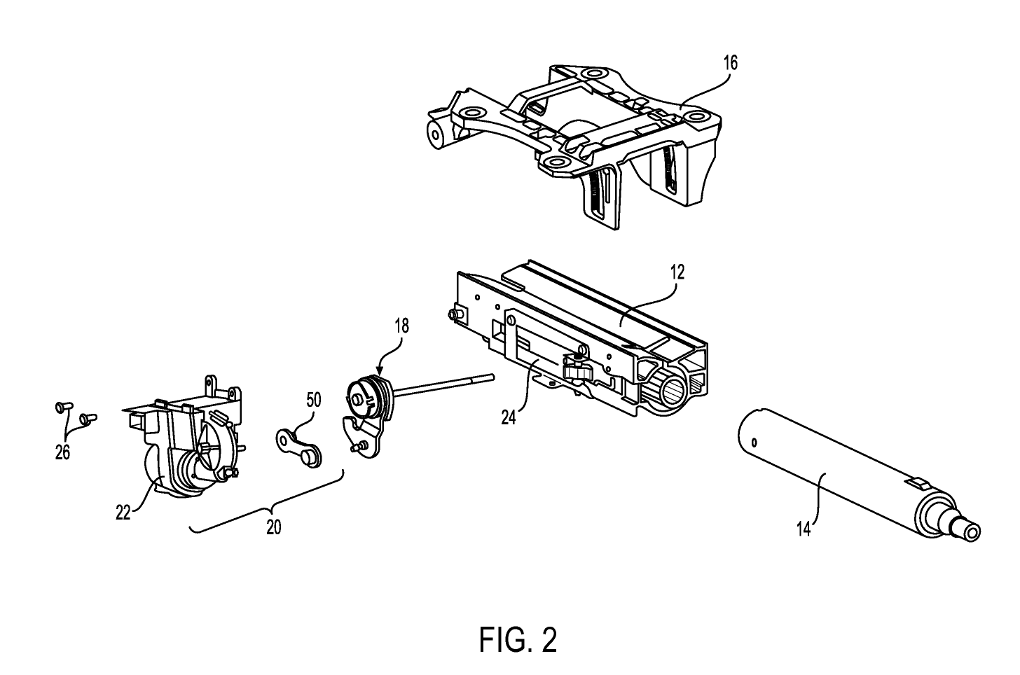

Referring to FIGS. 1 and 2, a steering column assembly 10 for a vehicle is illustrated. The steering column assembly extends between a steering wheel (not shown) and a steering gear (not shown). The steering column assembly 10 includes a stationary portion 12, also referred to as a “lower jacket,” and a moveable portion 14, also referred to as an “upper jacket.” The moveable portion 14 is in telescoping engagement with the stationary portion 12. The telescoping relationship between the moveable portion 14 and the stationary portion 12 advantageously allows a user to adjust a steering wheel (not shown) of a vehicle in a translatable manner to a desirable position. Additionally, the telescoping relationship facilitates a collapsible function of the steering column assembly 10 in the event of an energy absorption event, such as impact by the user with the steering wheel.

A steering column mounting bracket 16 is coupled to the vehicle and is coupled to the stationary portion 12 of the steering column assembly 10. A cam bracket assembly 18 is operatively coupled to the steering column mounting bracket 16 and is configured to selectively apply or release a clamping force to moveable portion 14 in response to a manual input by a vehicle operator or in response to a collapsible function. The application and releasing of the clamping force by the cam bracket assembly is controlled by an electronic release linkage assembly 20. The electronic release linkage assembly 20 includes an electronic release module 22 that comprises an actuator, such as a motor, that is operatively coupled to the cam bracket assembly 18 which applies the clamping force on the moveable portion 14.

The electronic release module 22 is operatively coupled to the stationary portion 12 of the steering column assembly 10 with a module mounting bracket 24. In the illustrated embodiment, the module mounting bracket 24 is directly coupled to the stationary portion 12, but it is to be appreciated that intervening components may be present in some embodiments. Coupling of the electronic release module 22 may be made in any suitable manner, such as with mechanical fasteners 26. Advantageously, mounting the electronic release module 22 to the stationary portion 12 avoids a cantilevered disposition of the electronic release module 22, thereby reducing excessive moments, while also accommodating the collapsibility requirements of the steering column assembly 10. Additionally, coupling the electronic release module 22 to the stationary portion 12 provides packaging options for different steering column designs, thereby enhancing the flexibility of the vehicles with which the electronic release module 22 may be mounted to without significant modification.

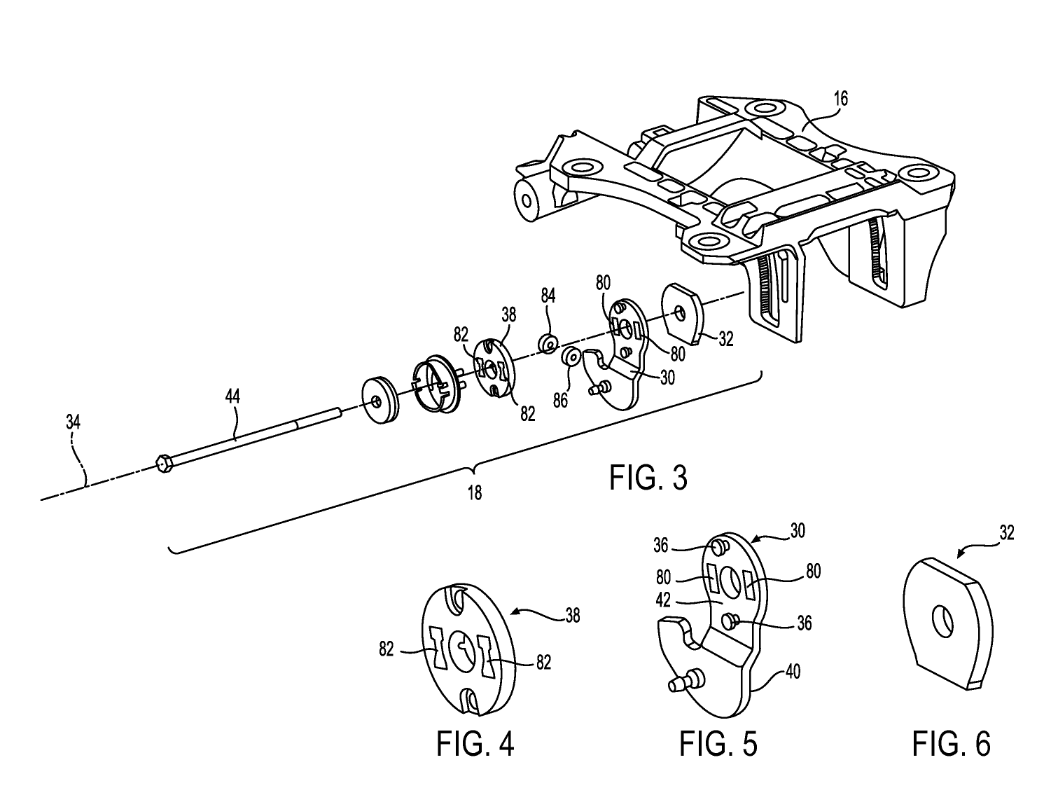

Referring now to FIG. 3-6, the cam bracket assembly 18 is illustrated in greater detail. The cam bracket assembly 18 includes a lever arm 30 and a cam 32 disposed on a first side 40 of the lever arm 30. The lever arm 30 is rotatable about a cam axis 34, with rotation of the lever arm 30 and translation of the cam 32 along the cam axis 34 controlling the clamping force applied to the stationary portion 12 of the steering column assembly 10, as described in detail below. The cam axis 34 is an axis that the lever arm 34 rotates about in response to an input torque from the electronic release module 22. In some embodiments, the lever arm 30 is formed of plastic or the like. In some embodiments, the cam 32 is formed of hardened powder metal or the like.

The lever arm 30 includes at least one protrusion 36 on a second side 42 of the lever arm 30 that establishes a reference datum for mounting of the lever arm 30 to a guide member 38. The guide member 38 is attached to the lever arm 30 by heat staking the components together in some embodiments, but it is to be appreciated that alternative joining methods are contemplated. In some embodiments, the guide member 38 is formed of steel or the like. A rake bolt 44 extends through the guide member 38, the lever arm 30 and the cam 32 along the cam axis 34. The rake bolt 44 may extend through apertures of additional components of the cam bracket assembly 18, as well as through the stationary and/or moveable portions 12, 14 of the steering column assembly 10 to fixedly secure the cam bracket assembly 18 to the stationary portion 12.

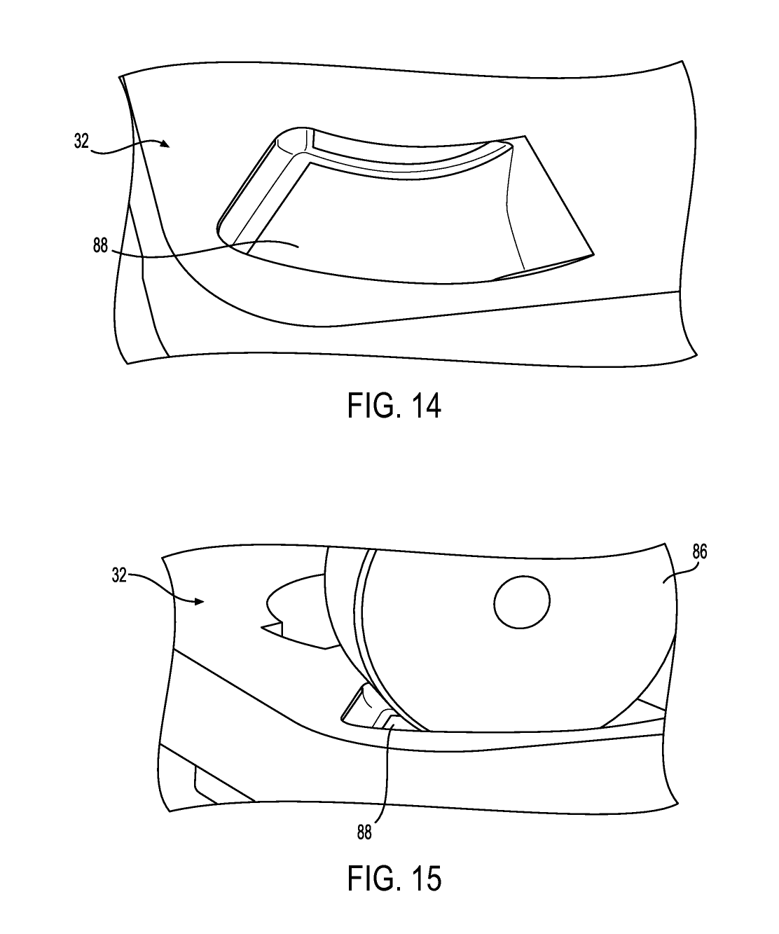

Referring now to FIGS. 13-15, with continued reference to FIGS. 3-6, the clamping force adjustment on the steering column assembly 10 is described in detail. The lever arm 30 includes at least one aperture, but a plurality of apertures is contemplated. In the illustrated embodiment, a pair of lever arm apertures 80 is defined by the lever arm 30 and each extends completely therethrough from the first side 40 to the second side 42 of the lever arm 30. Aligned with these apertures is a pair of guide apertures 82 that are defined by the guide member 38. Disposed within the lever arm apertures 80 and the guide apertures 82 is a first wheel 84 and a second wheel 86. The wheels 84, 86 are each configured to rotate about respective wheel axles integrally formed with or operatively coupled to the lever arm 30.

The wheels 84, 86 are positioned to protrude away from the first side 40 of the lever arm 30 to contact the cam 32. In particular, the wheels 84, 86 are each in contact with a cam ramp 88 that is disposed on a side of the cam 32 that is closest to the first side 40 of the lever arm 30. In operation, as the lever arm 30 rotates in response to input from the electronic release module 22, the wheel rides along the cam ramp 88 to adjust the clamping force exerted on the steering column assembly 10, thereby determining whether the steering column assembly 10 is in a locked or unlocked condition. This is achieved based on the wheel exerting a separation force on the cam 32 relative to the lever arm 30. The cam 32 is pinned to the stationary portion 12 of the steering column assembly 10 to prevent rotation of the cam 32, but the cam is permitted to move along the rake bolt 44 (i.e., cam axis 34) in a cross-car direction to provide the clamping force on the steering column.

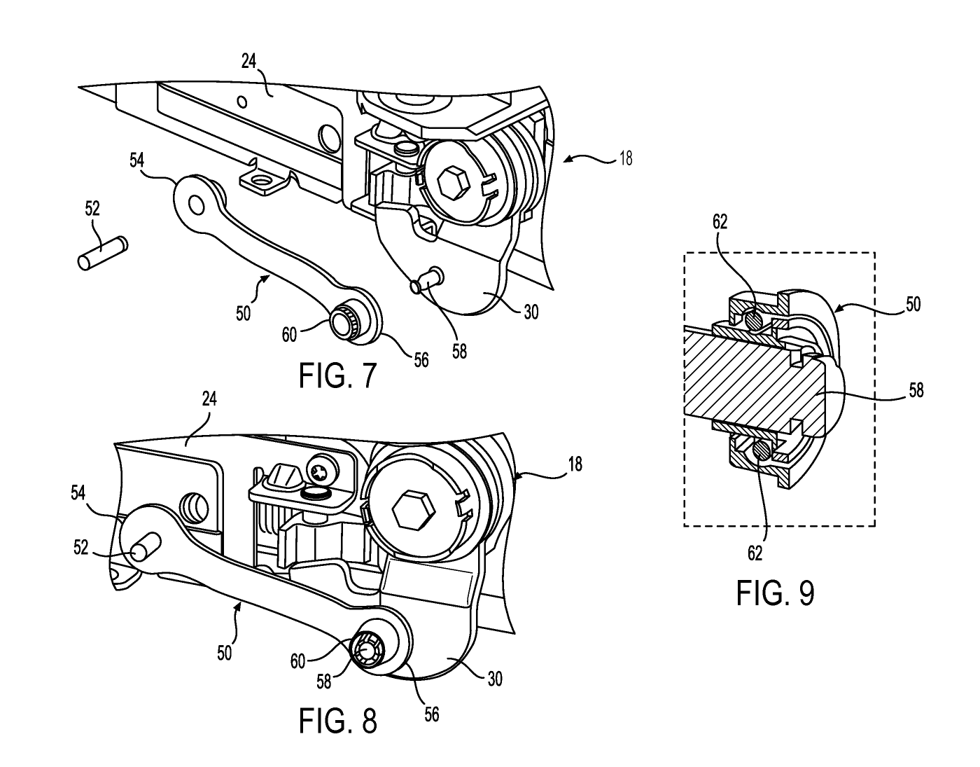

Referring now to FIGS. 7 and 8, a link member 50 is illustrated, the link member physically coupling the electronic release module 22 to the cam bracket assembly 18. In some embodiments, the link member 50 is formed of plastic or the like. The link member 50 is substantially symmetric along a length extending between the ends thereof However, deviations from perfect symmetry are contemplated in some embodiments.

A gear pin 52 extends from the electronic release module 22 as an integrally formed component or one operatively coupled thereto. Regardless of the connection of the gear pin 52, the gear pin 52 is operatively coupled to the link member 50 proximate a first end 54 of the link member 50. In the illustrated embodiment, the gear pin 52 extends through an aperture defined by the link member 50 proximate the first end 54. This connection establishes a physical connection between the link member 50 and the electronic release module 22 to provide an input from the electronic release module 22 to the link member 50 and the cam bracket assembly 18. Specifically, the link member 50 is operatively coupled to the cam bracket assembly 18 proximate a second end 56 of the link member 50. In the illustrated embodiment, the link member 50 is coupled to the lever arm 30 by inserting a lever pin 58 into an aperture defined by the link member proximate the second end 56. Coupling of the lever pin 58 to the second end aperture may be made with one or more clip members 60 disposed on the lever pin 58 or the wall defining the second end aperture. The lever pin 58 is snapped into engagement with the link member 50 upon insertion of the lever pin 58 into the aperture. Similar coupling may be employed for the gear pin 52 and the first end aperture. In some embodiments, the snap-on feature provided by the clip member(s) 60 is combined with bearing(s) 62 disposed proximate an inner wall that defines the link aperture (FIG. 9). The bearing arrangement may be present in one or both of the first end aperture and the second end aperture of the link member 50.

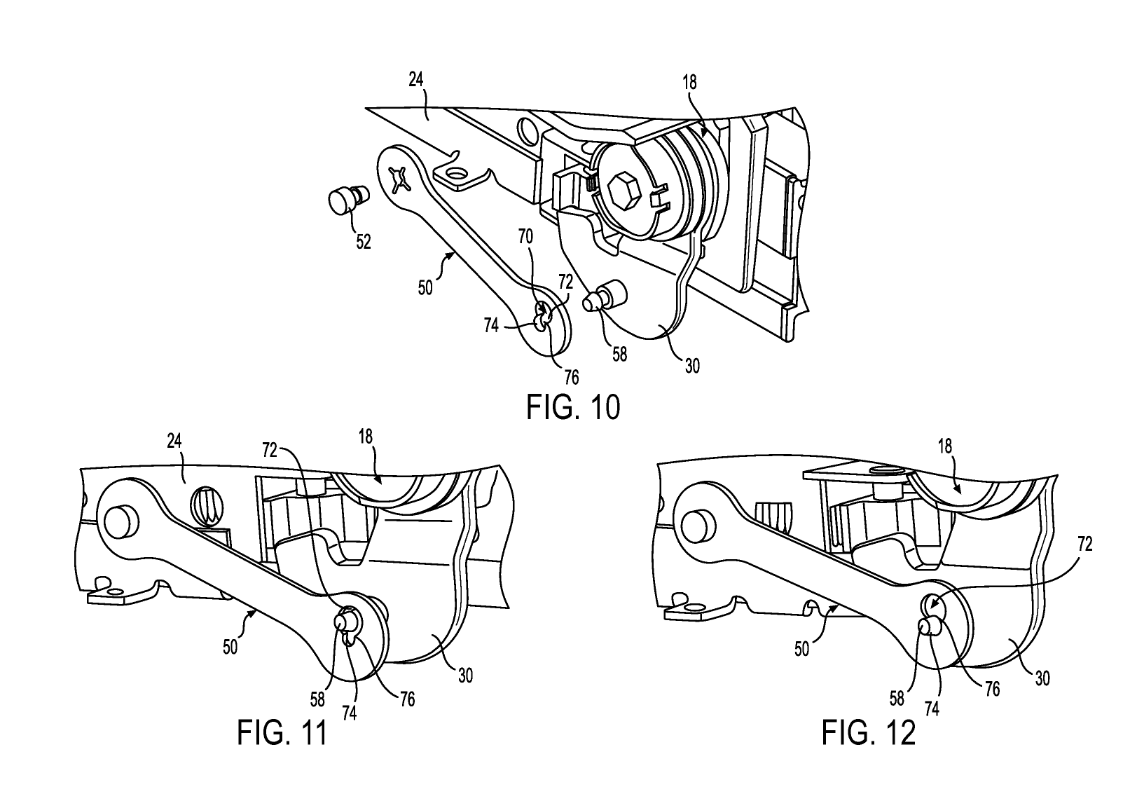

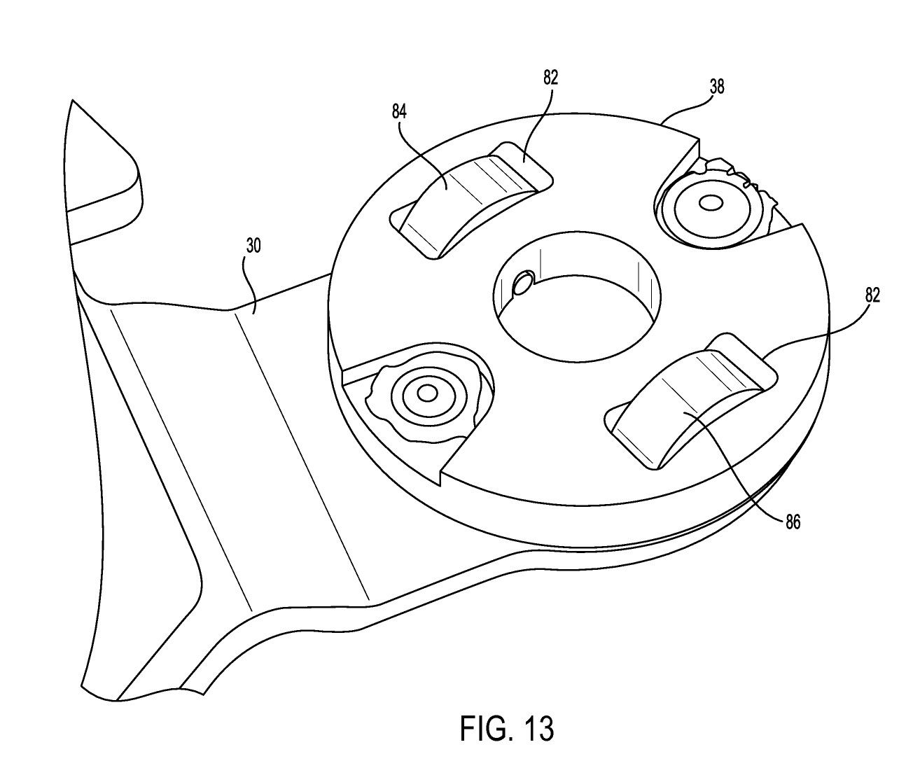

Referring now to FIGS. 10-12, another aspect of the disclosure is illustrated. In the illustrated embodiment, the link member 50 is similar in many respects to the embodiments described in detail above, such that similar reference numerals are employed and duplicative description of components is omitted. The second end aperture of the link member 50 is referenced with numeral 70 and includes a first portion 72, a second portion 74 and a neck portion 76 that separates the first portion 72 from the second portion 74. One of the first and second portions of the second end aperture 70 initially receive the lever pin 58 and the link member 50 is rotated to pass the lever pin 58 through the neck portion 76 and into the other portion of the second end aperture 70 to lock the lever pin 58 into place. In the illustrated embodiment, the lever pin 58 is initially inserted into the first portion 72 (FIG. 11) and subsequently locked into the second portion 74 (FIG. 12).

The embodiments described herein provide the advantages discussed above that are associated with avoiding direct coupling of the electronic release module 22 to the cam bracket assembly 18 that results in a cantilevered mounting of the module. Rather, the electronic release module 22 is mounted to the stationary portion 12 of the steering column assembly 10. Additionally, the link member 50 maintains a physical connection between the module and the cam bracket assembly to control the clamp force applied to the moveable portion 14 of the steering column assembly 10. The link member 50 transfers an input from the electronic release module 22 to drive rotation of the lever arm 30 to transmit the input.

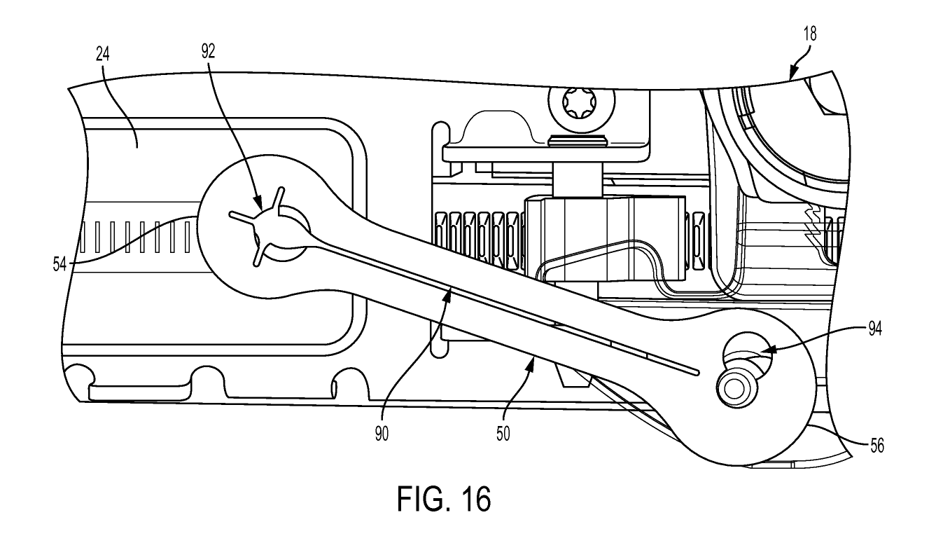

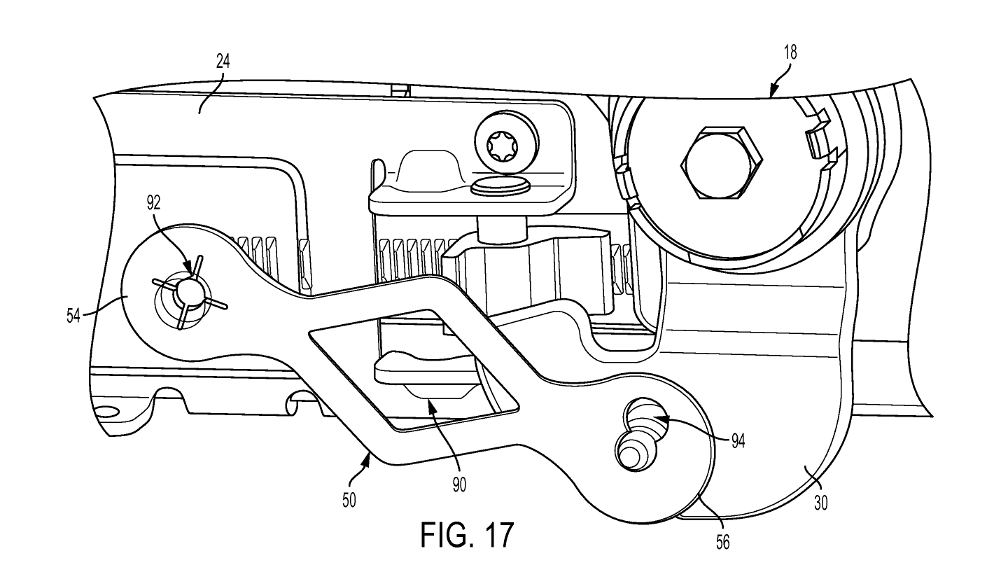

Referring to FIGS. 16 and 17, the link member 50 is illustrated to show another aspect of the disclosure. The link member 50 includes at least one cutout portion 90 to facilitate collapsibility of the link member 50 in response to application of a load greater than a predetermined load. In particular, the load may be applied indirectly to the link member 50 through one or more intermediate components. In one embodiment, a force is applied to the moveable portion 14 of the steering column assembly 10 and transmitted to the second end 56 of the link member 50.

In the illustrated embodiment, the cutout portion 90 extends in a longitudinal direction along the link member 90. Although illustrated as extending entirely from a first end aperture 92 to a second end aperture 94, it is to be appreciated that the cutout portion 90 may extend partially along the illustrated length. For example, the cutout portion 90 may extend from the first end aperture 92 to a longitudinal location that falls short of the second end aperture 94. Conversely, the cutout portion 90 may extend form the second end aperture 94 to a longitudinal location that falls short of the first end aperture 92. Additionally, the cutout portion 90 may not extend to the first end aperture 92 or the second end aperture. While a single cutout portion is illustrated, it is contemplated that multiple cutout portions may be present to facilitate collapsibility of the link member 50. The precise number of cutout portions, the orientation and the length thereof may be modified to tune the collapsibility of the link member 50. This provides the ability to adjust the load under which the link member collapses.

Although the cutout portion 90 is shown in the context of the link member shown in FIGS. 10-12, it is to be appreciated that the cutout portion 90 may be employed in any of the embodiments described and illustrated herein.

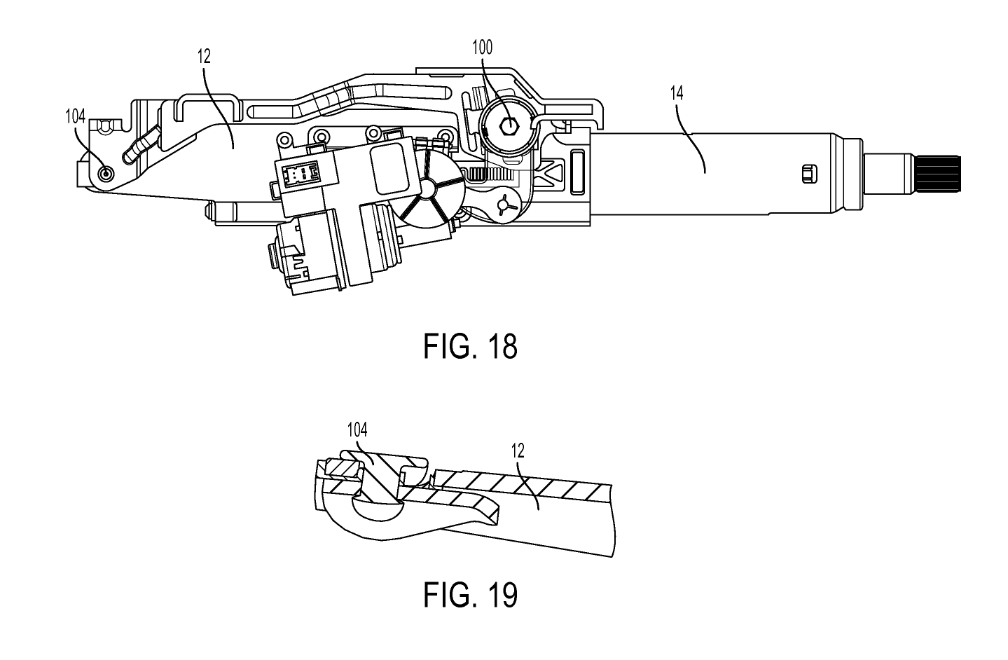

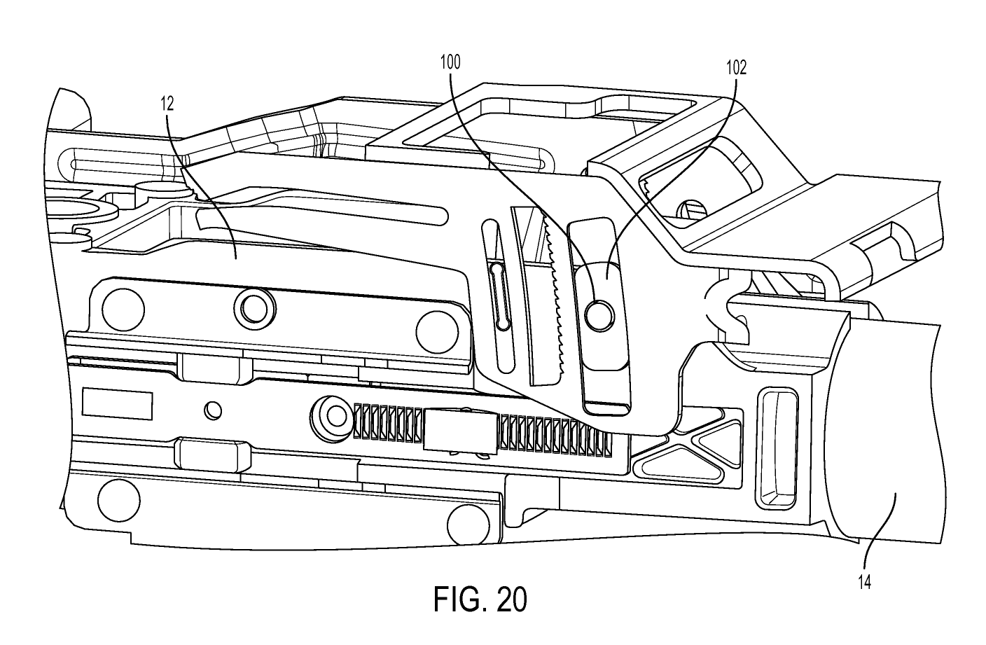

Referring now to FIGS. 18-20, an embodiment of the steering column assembly 10 is shown with a stationary rake bolt 100 and stationary rake pivot 104 included. It is to be appreciated that the stationary rake bolt 100 may be included with any of the embodiments disclosed herein, such that it may be rake bolt 44 discussed above. As discussed above, the stationary rake bolt 100 extends through one or more components, including the steering column mounting bracket 16. FIG. 20 illustrates the rake bolt 100 disposed in a guide member 102 inside the steering column mounting bracket 16. The steering column mounting bracket 16 is clamped to the stationary portion 12 of the steering column assembly 10. In response to an energy absorption event, the stationary portion 12 shuttles forward to reduce the clamp force on the moveable portion 14 of the steering column assembly 10, thereby allowing the moveable portion 14 to telescope during the energy absorption event. In some embodiments, the stationary portion 14 is configured to move about 2 millimeters to reduce the clamp force on the upper jacket.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, what is claimed is:

1. An electronic release linkage assembly for a vehicle steering column comprising:
a stationary portion of a steering column;
a module mounting bracket of an electronic release module, the module mounting bracket coupled to the stationary portion of the steering column;
a cam bracket assembly operatively coupled to a steering column mounting bracket, the cam bracket assembly configured to selectively apply a clamping force on the steering column upon receipt of input from the electronic release module, the cam bracket assembly comprising a lever arm rotatable about a cam axis; and
a link member that is collapsible and operatively coupled at a first link member end to the electronic release module with a gear pin extending from the electronic release module, the link member operatively coupled at a second link member end to the lever arm, the link member transferring an input from the electronic release module to drive rotation of the lever arm, the collapsible link member configured to collapse in response to a load imparted by the cam bracket assembly in excess of a predetermined load.

2. The electronic release linkage assembly of claim 1, wherein the first link member end comprises a first aperture to receive the gear pin and the second link member end comprises a second aperture to receive a lever pin extending from the lever arm.

3. The electronic release linkage assembly of claim 2, the link member comprising a cutout portion to facilitate collapsibility of the link member.

4. The electronic release linkage assembly of claim 2, wherein the cutout portion extends in a longitudinal direction of the link member.

5. The electronic release linkage assembly of claim 2, wherein at least one of the first link member end and the gear pin comprise at least one clip member to snap the first link member end and the gear pin into engagement upon insertion of the gear pin into the first aperture, at least one of the second link member end and the lever pin comprising at least one clip member to snap the second link member end and the lever pin into engagement upon insertion of the lever pin into the second aperture.

6. The electronic release linkage assembly of claim 5, wherein the first link member end comprises a bearing disposed proximate an inner wall of the link member that defines the first aperture.

7. The electronic release linkage assembly of claim 5, wherein the second link member end comprises a bearing disposed proximate an inner wall of the link member that defines the second aperture.

8. The electronic release linkage assembly of claim 2, wherein at least one of the first link member end and the gear pin comprise at least one clip member to snap the first link member end and the gear pin into engagement upon insertion of the gear pin into the first aperture, the second aperture comprising a first portion, a second portion and a neck portion separating the first portion and the second portion, the first portion initially receiving the lever pin and the second portion receiving the lever pin upon rotation of the link member.

9. The electronic release linkage assembly of claim 1, wherein the link member is symmetric along a length extending between the first link member end and the second link member end.

10. The electronic release linkage assembly of claim 1, wherein the cam bracket assembly further comprises:
a guide member disposed adjacent a first side of the lever arm;
a cam disposed adjacent a second side of the lever arm; and
a rake bolt extending through the guide member, the lever arm, and the cam along an axis that the lever arm rotates about in response to an input torque from the electronic release module.

11. The electronic release linkage assembly of claim 10, wherein the guide member is formed of steel.

12. The electronic release linkage assembly of claim 10, wherein the guide member is coupled to the lever arm with at least one protrusion extending from the lever arm that is heat staked to the guide member.

13. The electronic release linkage assembly of claim 10, wherein the rake bolt extends through the column mounting bracket and the stationary portion of the steering column.

14. A steering column assembly comprising:
a stationary portion of a steering column;
a moveable portion of a steering column in telescoping engagement with the stationary portion;
a module mounting bracket directly coupled to the stationary portion of the steering column;
an electronic release module operatively coupled to the module mounting bracket;
a steering column mounting bracket operatively coupled to the stationary portion of the steering column;
a lever arm of a cam bracket assembly operatively coupled to the steering column mounting bracket and rotatable about a cam axis; and
a link member that is collapsible and operatively coupled at a first link member end to the electronic release module and operatively coupled at a second link member end to the lever arm, the collapsible link member configured to collapse in response to a load imparted by the cam bracket assembly in excess of a predetermined load.

15. The steering column assembly of claim 14, wherein the first link member end comprises a first aperture to receive the gear pin and the second link member end comprises a second aperture to receive a lever pin extending from the lever arm.

16. The electronic release linkage assembly of claim 15, the link member comprising a cutout portion to facilitate collapsibility of the link member.

17. The electronic release linkage assembly of claim 15, wherein the cutout portion extends in a longitudinal direction of the link member.

18. The electronic release linkage assembly of claim 15, wherein at least one of the first link member end and the gear pin comprise at least one clip member to snap the first link member end and the gear pin into engagement upon insertion of the gear pin into the first aperture, at least one of the second link member end and the lever pin comprising at least one clip member to snap the second link member end and the lever pin into engagement upon insertion of the lever pin into the second aperture.

19. The electronic release linkage assembly of claim 15, wherein at least one of the first link member end and the gear pin comprise at least one clip member to snap the first link member end and the gear pin into engagement upon insertion of the gear pin into the first aperture, the second aperture comprising a first portion, a second portion and a neck portion separating the first portion and the second portion, the first portion initially receiving the lever pin and the second portion receiving the lever pin upon rotation of the link member.
